(19) United States
(12) Patent Application Publication
(10) Pub. No.: US 2026/0124591 A1
(43) Pub. Date: May 7, 2026

(54) SYSTEM AND METHODS FOR IMPROVING A PERFORMANCE OF A PRODUCTION PLANT

(71) Applicant: BASF SE, Ludwigshafen am Rhein (DE)

(72) Inventors: Marco Oskar Kennema, Ludwigshafen am Rhein (DE); Miriam Angela Anna Hahkala, Ludwigshafen am Rhein (DE); Olga Walz, Ludwigshafen am Rhein (DE); Dirk Hensel, Ludwigshafen am Rhein (DE)

(21) Appl. No.: 19/119,989

(22) PCT Filed: Oct. 12, 2023
(86) PCT No.: PCT/EP2023/078273

§ 371 Date: Apr. 10, 2025

(30) Foreign Application Priority Data
Oct. 14, 2022 (EP) 22201500.0

(51) Int. Cl. B01J 8/00; C01B 17/80

(52) U.S. Cl. CPC B01J 8/001; C01B 17/803; B01J 2208/00628; B01J 2208/00725

(57) ABSTRACT

The present invention relates to improving a performance of a production plant, in particular, in chemical industry. To this end, a method for determining a reactor performance for a catalytic reactor or reactor system is provided, the method comprising the steps of:—providing reactor data indicative of a property of the catalytic reactor or the reactor system,—providing catalyst configuration data indicative of a property of at least one catalyst present in the catalytic realtor or reactor system,—providing a reactor model associated with the least one catalyst, the reactor model being configured for determining a catalytic reaction within the catalytic reactor or reactor system based on the reactor data and the catalyst configuration data,—determining the reactor performance using the reactor data, the catalyst configuration data and the reactor model, and—providing the determined reactor performance for the provided catalyst configuration.

### TECHNICAL FIELD

The invention generally relates to improving a performance of a production plant, in particular, in chemical industry. In particular, the invention relates to a method for determining a reactor performance for a catalytic reactor or reactor system, a method for determining a plant performance of a production plant with a catalytic reactor or reactor system, and to a method for providing a target catalyst configuration for a catalytic reactor or reactor system. Moreover, the invention relates to a method for determining a target catalyst configuration for a production plant. Furthermore, respective systems, computer programs as well as computer-readable media for carrying out the methods are provided.

### BACKGROUND OF THE INVENTION

Fixed bed reactors or plug flow reactors are generally used for the synthesis of large-scale basic chemicals or intermediates or to treat toxic or harmful substances. Reactors typically have a layered and, in many cases, multi tubular design. Catalyst material may be provided in the form of pellets that can have different shapes and compositions. Owing to catalyst aging during use, the catalyst requires exchange in certain time intervals. To this end, in a first step, the aged catalyst is removed from a bed and then refilled in adequate volume. Refilling of the catalyst after the lifetime, is often required to meet the performance requirements of the production plant. Performance requirements are for instance yield, capacity, conversion, bed temperature and pressure drop. Yet, there is a large variety of catalysts differing in composition, shape, conversion and yield, making the choice of the optimal catalyst or combination of catalysts a cumbersome task that can lead to suboptimal results. A suboptimal catalyst selection can lead to reduced plant performance resulting in accumulated losses or increased emission levels over the lifetime of the catalyst.

Different model approaches to optimize catalytic processes through simulation exist. CN101980230A discloses a catalytic cracking reaction system process simulation optimization model and a solution method thereof. CN102034000B discloses a method for optimizing process operation of catalytic hydrogenation reaction of acetylene in an industrial device.

### SUMMARY OF THE INVENTION

The present invention is based on the objective to provide a more reliable approach to determine a reactor performance of a catalytic reactor or reactor system. In particular, the present invention is based on the objective to provide a more reliable approach for improving a performance of a catalyst in a catalytic reactor or reactor system. According to a further objective of the present invention, a more reliable approach to achieve an enhanced plant performance shall be provided. Furthermore, the present invention is based on the objective to provide an efficient, sustainable and reliable way of monitoring and/or controlling the filling of a reactor in a production plant, in particular, the filling of a catalytic reactor or reactor system with a catalyst. It is a further objective of the present invention to provide a more reliable approach to determine a target catalyst configuration for a catalytic reactor or reactor system.

According to the invention, a method, in particular, a computer-implemented method, for determining a reactor performance for a catalytic reactor or reactor system is proposed. The method comprises the steps of:
providing reactor data indicative of a property of the catalytic reactor or the reactor system, in particular, a digital representation of a property of the catalytic reactor or the reactor system,
providing catalyst configuration data indicative of a property of at least one catalyst present in the catalytic reactor or reactor system, in particular, a digital representation of a property of at least one catalyst,
providing a reactor model associated with the at least one catalyst, the reactor model being configured for determining a catalytic reaction within the catalytic reactor or reactor system based on the reactor data and the catalyst configuration data,
determining the reactor performance using the reactor data, the catalyst configuration data and the reactor model, and
providing the determined reactor performance for the provided catalyst configuration.

The invention includes the recognition that known methods typically focus on the optimization of plant operations. Such methods often lack reliability for plant operations with catalytic reactors since effects of the catalyst are not adequately included.

With the method for determining a reactor performance for a catalytic reactor or reactor system, it is possible to determine an effect of at least one catalyst present in the catalytic reactor or reactor system on the reactor performance. It is thus possible to improve a performance of a catalyst present in the catalytic reactor or reactor system. This is possible, e.g., since based on the determined effect of at least one catalyst, a property of that catalyst can be adapted to improve a performance of a catalyst in a catalytic reaction. As a result, it is possible to improve an efficiency of a chemical reaction. An improved efficiency of a chemical reaction has several advantages such as an optimized usage of catalyst material.

In particular, the method puts an operator of a production plant in a situation to determine the effect of catalyst composition comprising at least one catalyst on the reactor or plant performance. It is therefore possible to improve the reactor or plant performance based on the determined effect of the catalyst composition. For example, based on the determined effect of the catalyst composition, a property of the catalyst composition may be adapted to improve the performance of the catalyst composition in a catalytic reaction. This may result in an improved reactor or plant performance. Thereby, the method can be carried out prior to operation of the production plant or while or after operation of the production plant. Eventually, the method allows to adapt a catalyst composition to be used or used for improving the reactor performance and thereby the plant performance.

It is a particular advantage of the method, that the effect of the catalysts used in the reactor or reactor system is considered, since catalysts have a detrimental impact on the plant performance. Catalysts deactivate over time and replacements have to be done in regular intervals, which can range from multiple months to years, and require a shutdown of the plant. Catalyst changes are hence highly critical for current and future plant performance. If the catalysts are not chosen appropriately, the production plant will most probably not run effectively and the performance will be reduced. Such performance decrease can lead to high losses, since either an unnecessary plant shut down may be required or the plant runs for the catalyst lifetime at reduced performance. It is therefore advantageous to determine an effect of the catalyst composition and to improve a performance of the catalyst.

Before and owing to the multiple configurations of a catalytic reactor or reactor system and its catalysts, operators generally had to determine a catalyst composition that safeguards plant performance and is conform to yield and emission targets of the production plant. Yet, such determined catalyst composition often did not provide an optimized plant performance. Moreover, such determined catalyst composition often did not provide an optimized usage of catalyst material. With the proposed method for determining a reactor performance for a catalytic reactor or reactor system it is now possible to more reliably monitor and/or control the filling of a reactor in a production plant and thereby improve the performance of a catalyst. Furthermore, it is also possible to improve the performance of a production plant.

With the present invention and, in particular, with the proposed method for determining a reactor performance for a catalytic reactor or reactor system, it is possible to improve a performance of a catalyst. This is possible since an effect of at least one catalyst present in the catalytic reactor or reactor system on the reactor performance can be determined. Based on a determined effect of at least one catalyst present in the catalytic reactor or reactor system on the reactor performance, it is possible to adapt a property of the catalyst such as a catalyst composition. Thereby, the performance of a catalyst can be improved. In particular, with an improved performance of the catalyst, also the performance of a catalytic reactor or reactor system can be improved. Furthermore, with an improved performance of the catalyst, also a plant performance of a production plant with a catalytic reactor or reactor system can be improved.

The present invention, and, in particular, the proposed method for determining a reactor performance for a catalytic reactor or reactor system can enable an improvement of the efficiency of chemical reactions carried out in a catalytic reactor or reactor system, e.g., of a production plant. In particular, such chemical reactions may typically be carried out in the scale of tons. By enabling an improvement of the efficiency of chemical reactions in a catalytic reactor or reactor system, the present invention, and, in particular, the proposed method for determining a reactor performance for a catalytic reactor or reactor system, may require comparatively lower amounts of catalyst material. A more efficient use of catalysts in chemical reactions carried out in a catalytic reactor or reactor system may also enable a more time-efficient production. Generally, a more time-efficient production also decreases the amount of energy required and is thus beneficial for the environment.

Furthermore, since an improvement of the efficiency of chemical reactions carried out in a catalytic reactor or reactor system can be achieved with the present invention, and, in particular, with the proposed method for determining a reactor performance for a catalytic reactor or reactor system, it is possible to save resources for determining a performance of a catalyst according to the disclosure. That is, with the present invention, and, in particular, the proposed method for determining a reactor performance for a catalytic reactor or reactor system, the effect of a catalyst can be determined in advance or during operation and a property of the catalyst can be adapted to ensure an improved use and performance of the catalyst. Since chemical reactions are usually carried out in the scale of tons, a significant saving of resources may therefore be achieved with the present invention.

It is a particular advantage of the present invention and, in particular, of the proposed method for determining a reactor performance for a catalytic reactor or reactor system, that it is not limited to certain catalytic systems but can be applied broadly to any chemical reaction that can be specified by a reactor data indicative of a property of the catalytic reactor or the reactor system, catalyst configuration data indicative of a property of at least one catalyst present in the catalytic reactor or reactor system and a reactor model being configured for determining a catalytic reaction within the catalytic reactor or reactor system based on the reactor data and the catalyst configuration data. Some of the catalytic systems as described herein in the following are non-limiting examples intended to explain possible application cases of the present invention.

A possible catalytic reaction within a digital representation of catalytic reactor or reactor system that may be determined based on the reactor data and the catalyst configuration data when carrying out the method for determining a reactor performance for a catalytic reactor or reactor system may be but not limited to a styrene catalysis and a hydroformylation with 3,3′,3″-Phosphanetriyltris(benzenesulfonic acid) trisodium salt (TPPTS) or the like. The mentioned catalytic reactions are only considered exemplary and many further catalytic reactions may be determined when carrying out the method for determining a reactor performance for a catalytic reactor or reactor system. For example, a further non-limiting example of a catalytic reaction may involve the Lindlar catalyst, e.g., in a hydrogenation of alkynes to alkenes.

Taking the non-limiting example of hydroformylation of TPPTS, in the method for determining a reactor performance for a catalytic reactor or reactor system, reactor data may be indicative of the reactor type and may represent a digital representation of a plug flow reactor with one or more reactor beds. Furthermore, the reactor data may represent a digital representation of a bed volume for the one or more beds or the like. The catalyst configuration data may represent a digital representation of a property of at least one catalyst. For example, in the hydroformylation of TPPTS, rhodium or cobalt catalysts, e.g., rhodium or cobalt complexes in nonaqueous solution may be used. The reactor model may be configured to determine a catalytic reaction within a digital representation of a catalytic reactor or reactor system such as—in the case of hydroformylation of TPPTS—a two-phase homogeneous catalytic reaction such as a Ruhrchemie/Rhône-Poulenc process or the like based on the reactor data and the catalyst configuration data.

Taking the non-limiting example of styrene catalysis, the reactor data may represent a digital representation of a plug flow reactor or a dehydrogenation reactor or the like. The reactor data may furthermore represent a digital representation of the number of beds and their volumes or the like. The catalyst configuration data may represent a digital representation of properties of an aluminium chloride catalyst or a zeolite catalyst as often used in a styrene production from ethylbenzene or in case of a zeolite catalyst, also from toluene and methanol. In case, styrene shall be or is produced by the dehydrogenation of ethylbenzene, the catalyst configuration data may represent a digital representation of properties of an iron(III) oxide catalyst. Correspondingly, the reactor model configured for determining a catalytic reaction within a digital representation of the catalytic reactor or reactor system based on the reactor data and the catalyst configuration data may determine a catalytic reaction for the production of styrene such as a production from ethylbenzene, a dehydrogenation of ethylbenzene, or the like. For example, production from ethylbenzene, a Friedel-Crafts reaction between benzene and ethane may be determined based on a digital representation of a plug flow reactor as provided by the reactor data and a digital representation of an aluminium chloride or zeolites as a catalyst as provided by the catalyst configuration data.

Taking the non-limiting example of a hydrogenation of alkynes to alkenes making use of a Lindlar catalyst, the method for determining a reactor performance for a catalytic reactor or reactor system may include reactor data that may represent a digital representation of a tubular plug-flow reactor. The catalyst configuration data may represent a digital representation of a property of the Lindlar catalyst such as the Lindlar catalyst consisting of palladium deposited on calcium carbonate or barium sulfate, which may be poisoned with forms of lead or sulphur. The reactor model used in the method for determining a reactor performance for a catalytic reactor or reactor system may represent a digital representation of three components typically involved in the hydrogenation that are a digital representation of an unsaturated substrate such as alkene, alkyne, ester or the like, a digital representation of a hydrogen such as H₂ and, a digital representation of the Lindlar catalyst as provided by the catalyst configuration data. For determining the chemical reaction with the reactor model, also a digital representation of a tubular plug-flow reactor provided by the reactor data can be taken into account. The reactor model may furthermore be indicative of the temperatures and pressures to be used during the catalytic reaction. In the hydrogenation of alkynes to alkenes, generally, a platinum, palladium, rhodium, or ruthenium catalyst may be employed. For example, the reactor model may be used to determine a catalytic reaction involving a digital representation of Lindlar catalyst that can be used in a conversion process of phenylacetylene to styrene.

The above-described examples are only to be understood exemplary without limiting the range of applications of the present invention to these particularly mentioned and non-limiting examples. In fact, the present invention, and, in particular, the method for determining a reactor performance for a catalytic reactor or reactor system can be employed for catalytic systems in general. This is because the present invention and, in particular, the method for determining a reactor performance for a catalytic reactor or reactor system requires input that is common to catalytic systems in general, namely, reactor data indicative of a property of the catalytic reactor or the reactor system, catalyst configuration data indicative of a property of at least one catalyst present in the catalytic reactor or reactor system and a reactor model being configured for determining a catalytic reaction within the catalytic reactor or reactor system based on the reactor data and the catalyst configuration data. To name further non-limiting examples of chemical reactions that can be determined with the reactor model based on the reactor data and the catalyst configuration data may be the manufacture of epoxyethane from ethane using a silver catalyst, the halogenation of benzene using either aluminium chloride or aluminium bromide or iron as a catalyst, the reaction with chlorine in the presence of either aluminium chloride or iron, the reaction with bromine in the presence of either aluminium bromide or iron, the Friedel-Crafts alkylation of benzene in the presence of aluminium chloride as a catalyst, the Friedel-Crafts acylation of benzene, e.g., with a mixture of ethanoyl chloride, CH₃COCl, and aluminium chloride as the catalyst, or the Haber process for the synthesis of ammonia from nitrogen using mixtures of iron-potassium-calcium-aluminium-oxide as the catalyst, just to name a few.

According to the present invention, furthermore, a method, in particular, a computer-implemented method, for determining a plant performance of a production plant with a catalytic reactor or reactor system is proposed. The method comprises the steps of:
providing a plant model including reactor data indicative of a property of the catalytic reactor or the reactor system, in particular, a digital representation of a property of the catalytic reactor or the reactor system, and catalyst configuration data indicative a property of at least one catalyst present in the catalytic reactor or reactor system, in particular, a digital representation of a property of at least one catalyst present in the catalytic reactor or reactor system;
providing based on the reactor data and the catalyst configuration data a reactor performance for the catalytic reactor or reactor system by conducting the above-proposed method for determining a reactor performance for a catalytic reactor or reactor system,
determining the plant performance of the production plant based on the reactor performance and the plant model, and
providing the plant performance of the production plant.

Based on the reactor performance as determined with the above-proposed method for determining a reactor performance for a catalytic reactor or reactor system it is thus possible to obtain the plant performance of the production plant when furthermore using a plant model of that production plant. It is thus possible to determine how a reactor performance translates to the performance of the production plant as represent by the plant model. Thereby it is possible to adjust the property of at least one catalyst present in the catalytic reactor or reactor system and thereby the reactor performance to further improve the performance of the production plant.

According to present the invention, furthermore, a method, in particular, a computer-implemented method, for providing a target catalyst configuration for a catalytic reactor or reactor system is proposed. The method comprises the steps of:
providing one or more target performance(s) for the catalytic reactor or reactor system, in particular, a digital representation of one or more target performance(s), the one or more target performance(s) being indicative of a desired performance outcome when using the catalytic reactor or reactor system with the at least one catalyst present in the catalytic reactor or reactor system,
determining a reactor performance for a catalytic reactor or reactor system by conducting the above-proposed method for determining a reactor performance for a catalytic reactor or reactor system,
determining the target catalyst configuration, in particular, a digital representation of the target catalyst configuration, based on the determined reactor performance and the provided target performance(s), and
providing the determined target catalyst configuration.

With the method, it is thus possible to adjust the catalyst configuration to obtain a target catalyst configuration that enables a target performance of the reactor or reactor system. By providing the target catalyst configuration associated with a target performance for the catalytic reactor or reactor system, the performance of the production plant comprising the reactor or reactor system can be further improved, e.g., by carrying out the above-proposed method for determining a plant performance of a production plant with a catalytic reactor or reactor system. The operator may thereby be enabled to know what catalyst configuration is the target catalyst configuration to provide an improved performance of the production plant. Advantageously, the target catalyst configuration can be obtained prior to operation of the production plant such that the production plant may be operated immediately at an improved performance.

In combination with the above-proposed method for determining a reactor performance for a catalytic reactor or reactor system, the above-proposed for determining a plant performance of a production plant with a catalytic reactor or reactor system and the above-proposed for providing a target catalyst configuration for a catalytic reactor or reactor system, various further the embodiments may be realised some of which are elaborated in the following.

Preferably, in the above-proposed methods, determining the reactor performance comprises providing the reactor data and the catalyst configuration data to the reactor model. Based on the provided reactor data and catalyst configuration data, the reactor model can then determine a catalytic reaction within the catalytic reactor or reactor system. Based on the reactor model, the reactor data and the catalyst configuration data it is possible to determine the reactor performance.

Preferably, in the above-proposed methods, providing the reactor model includes generating the reactor model based on kinetic parameter(s) for different catalyst types of the at least one catalysts. Kinetic parameters may relate to the reaction kinetics of the reactor model. Kinetic parameters may depend on the catalyst type, in particular the catalyst shape and/or the catalyst composition. The reactor model may be associated with kinetic properties of the reactor. In particular, the reactor model for determining the catalyst configuration may be generated based on provided kinetic parameters. Additionally or alternatively, the reactor model may be associated with static properties of the reactor or reactor system.

The reactor model may include reaction properties, such as reaction rates and thermodynamic properties. The reactor model may include mass, energy and momentum balances. The reactor model may specify changes in state variables along the axial (length) direction of the reactor or of a reactor component of the reactor. Additionally or alternatively to changes along the axial (length) direction, changes in the radial direction of the reactor or of the reactor component of the reactor taken into account.

Preferably, in the above-proposed methods, the property of the at least one catalyst includes one or more catalyst type(s) and/or a catalyst volume associated with each catalyst type.

Preferably, in the above-proposed methods, providing the reactor model includes selecting kinetic parameter(s) based on catalyst type(s) of the at least one catalyst. A selection of kinetic parameter(s) may include a) a selection of kinetic parameter(s) associated with the catalyst type(s) and parametrizing the reactor model based the selected kinetic parameter(s) or b) a selection of a reactor model parametrized based on the kinetic parameter(s) associated with the catalyst type(s).

Preferably, the kinetic parameter(s) relate to experimental data for different catalyst types and/or reaction conditions, in particular for different catalyst compositions or catalyst volumes. Reaction conditions may include but are not limited to a reactor geometry, packaging of fixed bed (void fraction), and at what conditions a chemical reaction may run. The kinetic parameters may be determined experimentally from historical measurement data or from historic plant operation data per catalyst type. Kinetic parameters or the parametrized reactor model may be associated with metadata signifying the catalyst type, such as the catalyst composition, the catalyst volume and/or the catalyst shape. With different reactor models per catalyst type, the reactor performance may be determined for more than one catalyst type or combinations of catalyst types. Stacked configurations with more than one catalyst type in one or a single reactor component or more than one catalyst type in several reactor components may be determined. Such flexibility allows to provide more reliable catalyst configurations and improves the overall performance of the reactor.

Preferably, in the above-proposed methods, the property of the catalytic reactor or the reactor system includes one or more reactor component(s) that can be filled with a catalyst of the at least one catalyst and/or the property of the at least one catalyst includes catalyst type(s) and volume(s) per reactor component to be filled with a catalyst of the at least one catalyst.

Preferably, the reactor includes one or more reactor component(s). A reactor component may be a bed of the reactor or a catalyst layer. The catalyst configuration data may represent per reactor component to be filled with one or more catalyst composition(s), the catalyst shape associated with the catalyst composition and the catalyst volume associated with the catalyst composition. The catalyst configuration data may represent per reactor component to be filled with one catalyst composition. In such case, one or more shape(s) may be associated with the catalyst composition. In case of more shape(s), one volume may be associated with each shape. It may also be possible that for each shape, several volumes are associated with a respective shape. The catalyst configuration may include per reactor component to be filled more than one catalyst composition. In such case, one or more shape(s) may be associated with each catalyst composition. In case of one shape, one volume may be associated with such shape and composition. In case of more shape(s), one volume may be associated with each shape and composition.

Preferably, in the above-proposed methods, an aging factor signifying a catalyst deactivation per reactor component is provided. Preferably, the performance of the reactor is determined by providing the catalyst configuration data, the reactor data and the aging factor per reactor component to the reactor model. This is particularly advantageous, if only one or selected reactor component(s) of the reactor are to be filled. The aging factor may signify the catalyst deactivation over time. Such aging factor may relate to the catalyst type, its deactivation behaviour and/or the time the catalyst is already in use. The aging factor may be provided per catalyst type and/or per reactor component. In case of a fixed bed reactor or a plug flow reactor, the reactor component may be one bed in the reactor or a catalyst layer.

In the above-proposed methods, the performance of the reactor may be determined by providing the catalyst volume, the reactor data and the aging factor to the reactor model. Such input is advantageous, if different catalysts with different ages are present in the reactor, since varying ages of catalyst present in the reactor, e.g. in different beds, can be accounted for. Such capability is vital, if the reactor is subject to partial filling, where only selected components of the reactor are to be filled while the catalyst filling in others remains.

Preferably, in the above-proposed methods, determining the target catalyst configuration with respect to the provided target performance(s) includes an optimization routine determining the target catalyst configuration based on an objective function reaching a target objective. The objective function may relate to a target performance(s) of the reactor or the production plant. The target objective may be a stop criterion related to the objective function, such as an extremum, like a minimum or maximum of the objective function, a threshold value related to the objective function or a constraint related to the objective function. The objective function may relate to one or more reactor performance parameter(s). The reactor performance may relate to one or more of the following indicators for reactor performance: a conversion, a yield, an operation condition, a selectivity of the reactor or at least one component of the reactor. A product performance parameter may relate to one or more of the following parameters: product output, product output composition, energy usage, maintenance intervals.

As part of the above-proposed methods, the objective function or target performance may be determined for one or more catalyst type(s) and the catalyst type associated with the target objective may be provided. The catalyst type may be varied with respect to the catalyst composition or catalyst shape. Different catalyst types may be associated with or assigned to one reactor component of the reactor or reactor system, such as a bed or a catalyst layer. A first catalyst type may be associated with or assigned to a first reactor component of the reactor or reactor system and a second catalyst type may be associated with or assigned to a second reactor component of the reactor or reactor system. In the above-proposed methods, more than one catalyst type may be associated with or assigned to a reactor component to be filled.

Additionally or alternatively, in the above-proposed methods, the objective function or target performance may be determined for one or more catalyst composition(s) and the catalyst composition associated with the target objective may be provided. The catalyst composition may be varied with respect to the composition components and/or the component ratios or amounts. Different catalyst compositions may be associated with or assigned to one reactor component of the reactor, such as a bed or a catalyst layer. A first catalyst composition may be associated with or assigned to a first reactor component of the reactor and a second catalyst composition may be associated with or assigned to a second reactor component of the reactor. More than one catalyst composition may be associated with or assigned to a reactor component to be filled.

Additionally or alternatively, in the above-proposed methods, the objective function or target performance may be determined for one or more catalyst shape(s) and the catalyst shape associated with the target objective may be provided. The catalyst shape may be varied for different catalyst compositions. Different catalyst shapes may be associated with or assigned to one component of the reactor, such as a bed or a catalyst layer. A first catalyst shape may be associated with or assigned to a first reactor component of the reactor and a second catalyst shape may be associated with or assigned to a second reactor component of the reactor. More than one catalyst shape may be associated with or assigned to a reactor component to be filled.

In the above-proposed methods, the objective function or target performance may be determined by an optimization routine determining for different catalyst types and catalyst volumes respective performances until an objective function reaches a target objective signifying the target catalyst types and associated target catalyst volumes. The target objective may be determined based on a local optimization method, a global optimization method, metaheuristic optimization method or a combination of these methods providing at least one local, global or statistical target catalyst type and associated target catalyst volume. Additionally or alternatively, the target objective may be determined based on a deterministic optimization method, a stochastic optimization method, a heuristic optimization method, a combinatorial optimization method, a single optimization method, a multi-objective optimization method, a hierarchical optimization method, a gradient-based optimization method, a gradient-free optimization method, a quantum computing algorithm based optimization method or a combination of these methods providing at least one local, global or statistical target catalyst type and associated target catalyst volume. Preferably, target objective may be determined is based on mathematical optimization methods or a combination of these methods, which includes but is not limited to local, global, heuristic and metaheuristic methods. This way the operator receives different choices to select from with respective objectives to be met. The objective function may be based on output of the reactor, output composition of the reactor, catalyst performance, or profitability of the reactor.

According to the present invention, furthermore, a method for determining a target catalyst configuration for a production plant is proposed. The method comprises the steps of:
providing a plant model including reactor data and catalyst configuration data of a property of at least one catalyst present in a catalytic reactor or reactor system of the production plant, and, in a first option, comprises the steps of:
providing one or more target performance(s) for the catalytic reactor or reactor system,
providing a target catalyst configuration for the catalytic reactor or reactor system determined for a catalytic reactor or reactor system as described herein, and
determining the plant performance of the production plant based on the target catalyst configuration and the plant model,
   or, in a second option, comprising the steps of:
providing one or more target plant performance(s);
providing a reactor performance determined by conducting the above-proposed method for determining a reactor performance for a catalytic reactor or reactor system for at least one catalyst present in the catalytic reactor or reactor system, and
determining the target catalyst configuration with respect to the provided target plant performance(s) based on the plant model and the reactor performance for one or more catalyst configuration(s), and
providing the target catalyst configuration, the plant performance and/or the reactor performance of the production plant for the target catalyst configuration.

According to the present invention, furthermore, a method for determining operating conditions for a production plant is proposed. The method comprises the steps of:
providing a plant model and a target plant performance;
providing a target catalyst configuration with the corresponding method as described herein;
determining operating conditions for the plant based on the catalyst configuration, the plant model and the target plant performance, and
providing the operating conditions for monitoring or controlling the production plant.

According to the present invention, furthermore, a computer element is proposed including instructions for determining a reactor performance, a plant performance, a catalyst configuration or operating conditions, which when executed on one or more computing device(s), carry out the corresponding method as described above.

The present invention also relates to a use of the target catalyst configuration generated according to the above-proposed method for providing a target catalyst configuration for a catalytic reactor or reactor system for operating a plug flow reactor, for producing sulfuric acid, for monitoring a filling operation or for operation of a production plant.

According to the present invention, also, a system for determining a reactor performance of a catalytic reactor or reactor system, a plant performance, a catalyst configuration or operating conditions for a production plant is proposed, the system comprising the computer element as described above and one or more computing device(s) configured for executing the instructions included by the computer element.

In particular, for carrying out the above-proposed method for determining a reactor performance of a catalytic reactor or reactor system, a system for determining a reactor performance for a catalytic reactor or reactor system may be employed. The system comprises:
a reactor data providing unit configured for providing reactor data indicative of a property of the catalytic reactor or the reactor system,
a catalyst configuration data providing unit configured for providing catalyst configuration data indicative of a property of at least one catalyst present in the catalytic reactor or reactor system,
a reactor model providing unit configured for providing a reactor model associated with the at least one catalyst, the reactor model being configured for determining a catalytic reaction within the catalytic reactor or reactor system based on the reactor data and the catalyst configuration data,
a reactor performance determination unit configured for determining the reactor performance using the reactor data, the catalyst configuration data and the reactor model, and
a reactor performance output unit configured for providing the determined reactor performance for the provided catalyst configuration.

For carrying out the above-proposed method for determining a plant performance of a production plant with a catalytic reactor or reactor system, a system for determining a plant performance of a production plant with a catalytic reactor or reactor system may be employed. The system comprises
a plant model providing unit configured for providing a plant model including reactor data indicative of a property of the catalytic reactor or the reactor system and catalyst configuration data indicative a property of at least one catalyst present in the catalytic reactor or reactor system;
the system for determining a reactor performance for determining a reactor performance for a catalytic reactor or reactor system as described before,
a plant performance determination unit configured for determining the plant performance of the production plant based on the reactor performance and the plant model, and
a plant performance providing unit configured for providing the plant performance of the production plant.

For carrying out the above-proposed method for providing a target catalyst configuration for a catalytic reactor or reactor, a system for providing a target catalyst configuration for a catalytic reactor or reactor system is proposed. The system comprises:
a reactor data providing unit configured for providing reactor data indicative of a property of the catalytic reactor or the reactor system,
a catalyst configuration data providing unit configured for providing catalyst configuration data indicative of a property of at least one catalyst present in the catalytic reactor or reactor system,
a reactor model providing unit configured for providing a reactor model associated with the at least one catalyst, the reactor model being configured for determining a catalytic reaction within the catalytic reactor or reactor system based on the reactor data and the catalyst configuration data,
a target performance providing unit configured for providing one or more target performance(s) for the catalytic reactor or reactor system, the one or more target performance(s) being indicative of a desired performance outcome when using the catalytic reactor or reactor system with the at least one catalyst present in the catalytic reactor or reactor system,
a catalyst configuration determination unit configured for determining the target catalyst configuration with respect to the provided target performance(s)based on the reactor data, the catalyst configuration data and the reactor model, and
a target catalyst configuration providing unit configured for providing the determined target catalyst configuration.

According to the invention, furthermore, a method for determining a performance of a production plant with a catalytic reactor or reactor system is proposed. The method comprises the steps of:
providing a plant model based on a production plant layout and a target performance of the production plant,
determining a reactor performance for at least one catalyst used in a catalytic reactor according to the above-proposed method for determining a reactor performance for a catalytic reactor or reactor system,
determining a plant performance of the production plant based on the plant model and a catalyst volume or catalyst type of the at least one catalyst,
providing a catalyst configuration and the associated performance of the production plant.

The present invention also relates to an apparatus for determining a performance of a production plant with a catalytic reactor. The apparatus can be used for carrying out the above-described method for determining a target performance of a production plant with a catalytic reactor or reactor system and comprises:
a memory adapted to store run-time data for the determination of a performance, and
   at least one processor that is adapted to store and execute processor-executable instructions that, in response to execution, enables the determination of a performance, including:
providing a plant model based on a production plant layout and a target performance of the production plant;
determining a performance for at least one catalyst used in a catalytic reactor or reactor system using the apparatus for determining a performance of a reactor or a reactor system with a catalytic reactor as lined out above performing the method lined out above,
determining a performance of the production plant based on the plant model and the catalyst volume or type, and
providing the catalyst configuration and the associated performance of the production plant.

In the above-described method and the apparatus for determining a performance of a production plant with a catalytic reactor or reactor system, the target performance of the production plant may be determined by an optimization routine determining a performance where an objective function reaches a target objective signifying target catalyst types and associated target catalyst volumes. For instance the target performance of the production plant may be determined by an optimization routine determining e.g. for different catalyst types and catalyst volumes respective performances until an objective function reaches a target objective signifying e.g. the target catalyst types and associated target catalyst volumes. The target objective may be determined based on a local optimization method, a global optimization method, metaheuristic method or a combination of these methods providing at least one local, global or statistical target catalyst type and associated target catalyst volume. This way the operator receives different choices to select from with respective objectives to be met.

The objective function used therein may relate to an output of the production plant, product output composition, catalyst performance, operating parameters of the production plant or profitability of the production plant. The plant model may relate to a process model of a production plant as input to the flow sheet simulation. The flow sheet simulation may solve energy and mass balance equations based on chemical input parameters, unit operations and operating conditions.

Explanation of terms used herein:

Reactor data indicative of a property of the catalytic reactor or the reactor system refers to a digital representation of the reactor or reactor system or a specification of the reactor or reactor system. The reactor data may include data associated with a reactor type. In a preferred embodiment the reactor type is a plug flow reactor. Such reactors include one or more reactor beds to be filled with catalyst. The reactor data may further include a reactor geometry, the number of beds, a free bed area for the one or more beds, a bed height for the one or more beds, a bed volume for the one or more beds, an inlet gas specification, such as total gas flow or gas composition, temperature specification, such as inlet temperature of the inlet stream to the reactor or per bed, pressure specification, such as such as inlet pressure of the inlet stream to the reactor or per bed. Additionally the reactor data may include data associated with processing components of the reactor, such as heat exchangers, absorption units or gas quenches situated inside or outside of the reactor e.g. following a bed or following the reactor outlet. More than one reactor data may be provided, wherein for different reactor data the performance of the reactor or reactor system may be determined.

Catalyst configuration data indicative of a property of at least one catalyst may specify the configuration of the catalyst in the reactor or reactor system. The catalyst configuration data may be associated with one component of the reactor or multiple components of the reactor. The catalyst configuration data may represent at least a catalyst type and/or a catalyst volume. The catalyst configuration data may represent one or more dimensional data set indicating reactor type, reactor component, catalyst configuration including catalyst composition(s), catalyst shape(s) and catalyst volume(s) per reactor or reactor component. The catalyst configuration data may specify one or more catalyst type(s) per reactor or per reactor component, such as per reactor bed. Alternatively or additionally, the catalyst configuration data may specify one or more the catalyst volume(s) per reactor or per reactor component, such as per reactor bed.

Catalyst type refers to digital representation or a specification of the catalyst to be used in the reactor or reactor system. The catalyst type may include a composition of the catalyst. The catalyst type may include the components of the composition and their respective amounts. Catalyst type may further include a shape of catalyst extrudates.

Catalyst shapes may include pellets, rings, star-rings or quattro rings joining four rings to a shamrock-type shape. In case of a fixed-bed reactor or plug-flow reactor, the catalyst type may relate to one or more catalyst type(s) per bed. Further shapes and compositions of physical catalysts the catalyst configuration may be associated with are inter alia described in WO 2021/013682 A1.

Catalyst composition may be pre-defined or may refer to individual components of the catalyst composition. Such catalyst composition may be associated with different components of the catalyst material such as catalytically inactive or active components. For instance, the catalyst composition may be associated with catalytically active materials. Catalytically active materials may be metal, metal alloy or metal oxide particles. Examples are silicon dioxide, aluminum oxide, diatomaceous earth, titanium dioxide, zirconium dioxide, magnesium oxide, calcium oxide, hydrotalcite, spinels, perovskites, metal phosphates, metal silicates, zeolites, steatites, cordierites, carbides, boron nitrides, metal-organic frame works and mixtures thereof.

Catalyst volume refers to a volume of the reactor to be filled with catalyst. In case of a fixed-bed reactor or a plug-flow reactor, the catalyst volume may relate to the volume to be filled with catalyst per bed, in particular, the volume to be filled with the catalyst type per bed. If the catalyst volume is considered per bed, catalyst configuration can be determined in a more granular level considering catalyst type(s) and the effects of filling different beds with different catalyst volume(s) or type(s) can be accounted for. Hence, the catalyst configuration per bed provides a degree of freedom on a per bed basis allowing to optimize the reactor performance. In addition, one bed can be filled with several catalyst types differing in composition and/or shape. Alternatively to a catalyst volume, a catalyst mass may be used.

Performance of the reactor refers to an operative measure that signifies the reactor performance in the production process the reactor is used. Performances may include total conversion of the reactor, conversion per bed in case of a fixed bed plug flow reactor, selectivity of the catalyst, yield of the reactor, amount of certain components in the outlet stream of the reactor, pressure drop, a price of a catalyst or temperature gradient.

Performance of a plant refers to an operative measure that signifies the plant performance in the production process. Plant performances may include yield and emission targets of the production plant, e.g. the amount per time unit or the quality of emission targets.

Target performance may be defined with respect to a target objective such as a target conversion, a target yield, a target operation condition, a target selectivity of the reactor or at least one component of the reactor.

A plant model can be a digital representation of a plant, e.g., representing the layout of the plant.

A reactor system may comprise two or more reactors. The two or more reactors may for example be connected to each other in series.

It shall be understood that any of the apparatuses as described above, any of the systems as described above, any of the methods as described above, and any of the computer program elements as described above have similar and/or identical preferred embodiments, in particular, as defined in the dependent claims and above described embodiments.

It shall be understood that a preferred embodiment of the present disclosure can also be any combination of the dependent claims or above embodiments with the respective independent claim.

These and other aspects of the disclosure will be apparent from and elucidated with reference to the embodiments described hereinafter.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

FIG. 1: illustrates one example of fixed bed reactors with different catalyst configurations in different reactor beds.

FIG. 2: illustrates one example of a sulfuric acid production plant with fixed bed reactor.

FIG. 3: illustrates a block diagram of one example environment with computing device(s) and production plant.

FIG. 4: illustrates a flow diagram of one example method for determining a reactor performance for a catalyst configuration.

FIG. 5: illustrates an example of an input interface for determining the reactor performance.

FIGS. 6,7,8: illustrate results from the method for determining reactor performance.

FIG. 9: illustrates a flow diagram of one example method for determining a plant performance for the catalyst configuration.

FIG. 10: illustrates a flow diagram of one example method for optimizing the catalyst configuration.

FIG. 11: illustrates a flow diagram of another example method for optimizing the catalyst configuration.

FIG. 12: illustrates a flow diagram of one example method for monitoring and controlling a filling operation.

FIG. 13: illustrates a flow diagram of another example method for monitoring and controlling a production plant operation.

### DETAILED DESCRIPTION OF EMBODIMENTS

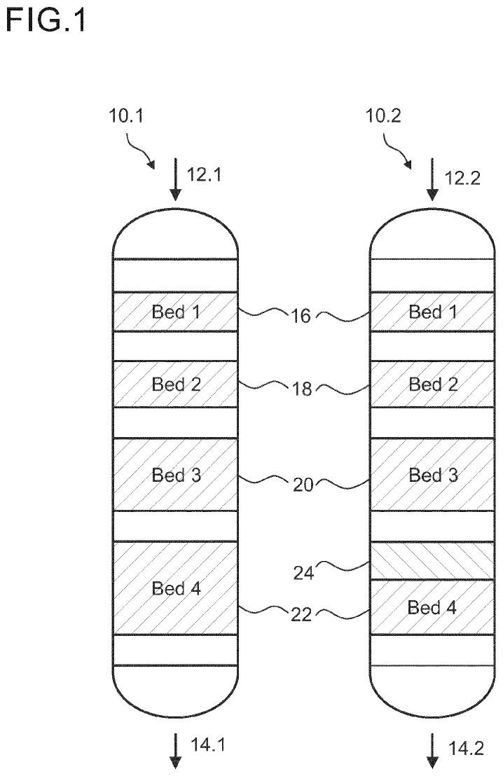

FIG. 1 illustrates one example of fixed bed reactors with different catalyst configurations in different reactor beds.

In the illustration of FIG. 1, the fixed bed reactors 10.1, 10.2 include an inlet 12.1, 12.2, an outlet 14.1, 14.2 and four reactor beds 16, 18, 20, 22 filled with catalyst material as reactor components. Further reactor components may be heat exchangers, gas quenchers, air quenchers or absorbers. In this case, it may be catalyst extrudates comprising different catalyst types. For instance, the catalyst types may vary in shape and/or composition. The shape of the catalyst extrudates may influence the catalytic reaction with respect to the pressure drop and the geometric surface area. Shapes include for instance pellets, tablets, ring shapes, star-ring shapes, or quattro ring shapes joining four rings to a shamrock-type shape. Shapes may have different dimensions ranging from 3 mm to 20 mm. The composition of the catalyst extrudates may vary with respect to the carrier material and/or the active compounds. The carrier material may influence the accessibility of active sites and the mechanical strength. The active compounds may influence the catalytic reaction with respect to the number of active sites and the promoter composition.

Depending on the performance requirements of the plant or reactor 10.1, 10.2 and the catalyst types, the filling of the reactor beds 16, 18, 20, 22 may vary. For the reactor 10.1, shown on the left-hand side of FIG. 1, the beds 16, 18, 20, 22 are fully filled with catalyst extrudates of a single type. The volume of the catalyst beds 16, 18, 20, 22 varies across the reactor 10.1 with the lowest bed height for bed 16—the ignition bed—and the largest bed height for bed 22 situated in flow direction before the outlet 14.1.

For the reactor 10.2, shown on the right-hand side of FIG. 1, the beds 16, 18, 20 are fully filled with catalyst extrudates of a single type, while bed 22 is not fully filled. Similarly, to the reactor 10.1, the volume of the catalyst beds 16, 18, 20, 22 varies across the reactor 10.2 with the lowest bed height for bed 16—the ignition bed—and the largest bed height for bed 22 situated in flow direction before the outlet 14.2. In contrast to the reactor 10.1, the catalyst extrudates in bed 22 differ from the catalyst extrudates of beds 16, 18 and 20 in shape. By using a quattro ring shape rather than a star ring shape, the catalyst configuration of bed 22 can be reduced by 30 %, as indicated by reference numeral 24, at constant performance such as pressure drop, conversion and yield. This way, the filling with catalyst extrudates can be reduced to save catalyst material while operating under constant conditions. The reduction in required catalyst material allows for more sustainable operation. To enable such operation modes while adhering to reactor and plant performance requirements, it is beneficial to provide plant operators with an optimal catalyst configuration that fulfills environmental as well as technical performance requirements.

The catalyst configurations mentioned here are mere examples and should not be limiting. They may vary with respect to catalyst type and/or volume for one bed or across beds. The types may vary with respect to composition and/or shape for one bed or across beds. The catalyst configuration can include many more complex configurations with mixed or layered configurations per bed and/or differing configurations across the beds.

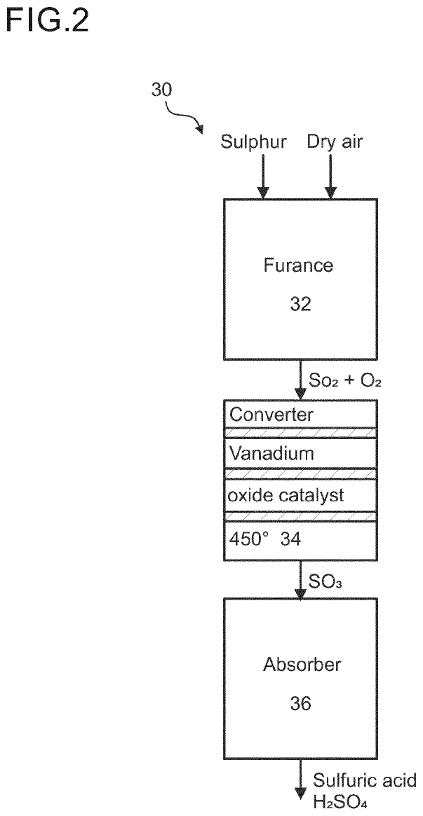

FIG. 2 illustrates one example of a sulfuric acid production plant 30 with a fixed bed reactor 34.

One industrial process including fixed bed reactors 34 is sulfuric acid production. Sulfuric acid is obtained by oxidation of sulfur dioxide (SO₂) to sulfur trioxide (SO₃) in the contact/double contact process with subsequent hydrolysis. In this process, molten sulfur is burned under air in a furnace 32 to release SO₂ to the fixed bed reactor 34. In the fixed bed reactor 34, SO₂ is oxidized by means of molecular oxygen through an air feed over vanadium-comprising catalysts in a plurality of consecutive adiabatic beds to form SO₃. The SO₂ content of the feed gas is usually in the range from 0.01 % to 50 % by volume and the ratio of O₂/SO₂ is in the range from 0.5 to 5. A preferred oxygen source is air. Part of the sulfur dioxide is reacted in the individual beds, with the gas being in each case cooled between the individual beds (contact process). SO₃, which has already been formed can be removed from the gas stream by intermediate absorption in order to achieve higher total conversions (double contact process). The reaction occurs, depending on the bed, in a temperature range from 340° C. to 680° C., with a maximum temperature decreasing with increasing bed number because of the decreasing SO₂ content. Sulfur trioxide is then fed to an absorber 36, where concentrated sulfuric acid is released through outlet of absorber 36.

Sulfuric acid production is only one example for a potential production plant with catalytic reactor. Further catalytic reactors, where a catalyst configuration with different types of catalysts plays a role, include catalysts for selective hydrogenation of alpha methylene styrene (AMS) to cumene, hydrogenation of phenol, selective hydrogenation of phenol to cyclohexanone or the like.

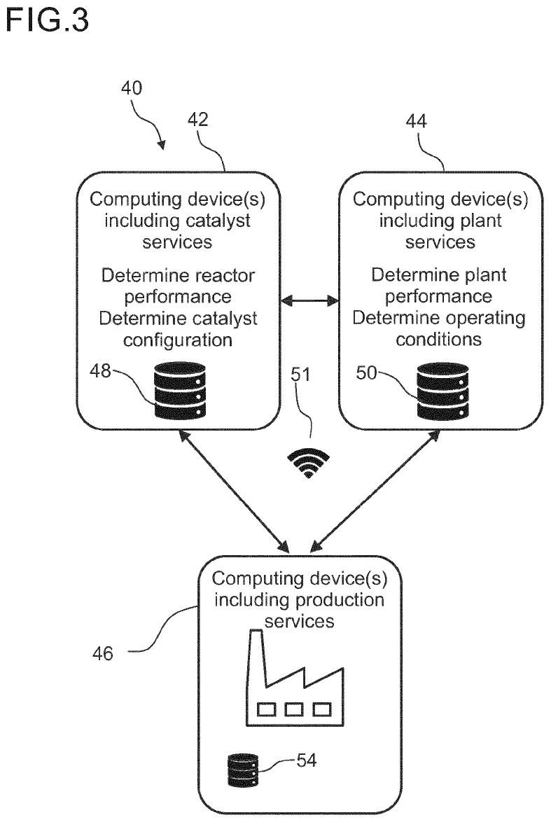

FIG. 3 illustrates a block diagram of one example for a suitable computing environment 40, in which aspects of the technology may be implemented.

The distributed computing system 40 includes a catalyst computing system 42 with a storage device or data base 48, e.g., for reactor components of the reactor model, a plant model computing system 44 with storage device or data base 50, e.g., for plant components of the plant model, an network 50 enabling communication and an production plant system 46 for operating the plant. The storage devices 48, 50, 54 may be, e.g., a persistent or non-persistent data storage devices. They may be configured to store plant data from one or more production plants or lab scale plants. The storage devices 48, 54 may store one or more reactor model(s), one or more kinetic parameter(s) per catalyst type, one or more reactor model(s) per catalyst type, one or more plant model(s) or one or more digital representation(s) of production plant(s). The methods disclosed herein may be implemented in a cloud-based model execution environment with a web-based graphical user interface. The computing device(s) may be configured to execute instructions to provide reactor performance, plant performance, catalyst configuration or operating conditions. The distributed computing system 40 may further be configured to execute instructions to provide a reactor model based on kinetic parameters depending on catalyst type, to determine kinetic parameters based on historic data depending on catalyst type, to determine reactor or plant performance based on reactor model(s) or to determine optimal catalyst configuration(s) reaching target performances for the reactor or the production plant.

The catalyst computing system 42, the plant model computing system 44 and the production plant system 46 may be connected via an external network 51 to transfer data between the components of the distributed computing system 40. For instance, a client device may trigger the determination of the optimal catalyst configuration via the distributed computing system 40. The distributed computing system 40 may provide the determined catalyst configuration to the client device or directly to the production plant to trigger filling of the catalytic reactor. Similarly, during production, operating conditions may be provided in connection with the catalyst configuration for optimizing, monitoring or controlling the production plant.

This way an optimal catalyst configuration fulfilling the technical performance requirements of the production plant may be provided and the reactor/plant models may be further improved based on operating conditions from the production plant. This allows to analyze the performance of a catalyst configuration in fixed bed reactors e.g. for gas phase sulfuric acid production. The systems and methods allow to make determinations on catalyst configuration achieving technical performance requirements of the production process. Various catalyst configurations may be compared to determine the optimal catalyst configuration required for the fixed bed reactor in the industrial production setting.

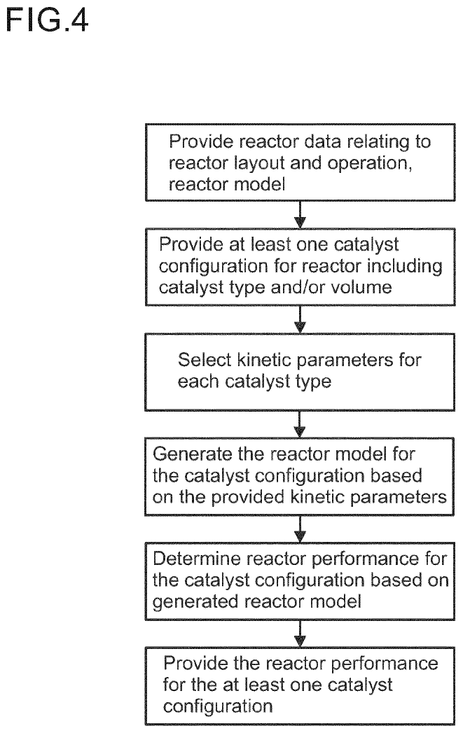

FIG. 4 illustrates a flow diagram of one example method for determining the reactor performance for a given catalyst configuration.

In a first step, reactor data relating to the reactor layout and operation such as bed layout, temperature, pressure or inlet composition are provided. Such data may be provided via a network from the client device via any computing device. A user may specify the reactor system, e.g., reactor geometry, number of fixed beds, reactor inlet composition, inlets into each individual fixed bed like inlet flow rates, inlet temperatures, as well as processing steps between the fixed beds, if more than one is present such as heat exchangers or the like. In another embodiments reactor data may be provided via a computing device accessing the storage device configured to store the reactor data.

In a second step, at least one catalyst configuration for the reactor including catalyst type and/or volume are provided via catalyst configuration data. The catalyst type may be rep-resented in a two or more-dimensional dataset indicating catalyst shape and catalyst composition per reactor component, e.g. per reactor bed. At least one catalyst volume for each catalyst type may be determined based on the reactor layout. Catalyst configuration data may be provided via the network 50 from the client device or any computing device 42, 44, 46. A user may specify the catalyst types including potential stacking configuration(s) per reactor component or inside each component.

In a third step, kinetic parameters for each catalyst type may be selected. Such kinetic parameters may be determined from historical experimental or plant operation data for the respective catalyst type. In particular kinetic parameters may be determined from historical experimental or plant operation data for the respective catalyst composition and/or shape. The selection of kinetic parameters may further be based on production plant types. The production plant type may refer to the type of reaction the catalyst catalyzes, the requirements of the production plant or any other suitable indicator for the production plant.

In a fourth step, the reactor model for the catalyst configuration based on the provided kinetic parameters may be generated. In this method, the reactor model framework and the kinetic parameters may be separately stored in a database. The catalyst type may be attached to the kinetic parameters associated with the respective catalyst type as metadata. Based on the provided catalyst type the appropriate kinetic parameters may be selected. Alternatively, the parametrized reactor model may be stored in a database. The catalyst type, e.g. composition and/or shape, may be attached as metadata to the reactor model. Based on the provided catalyst type the appropriate reactor model may be selected. Steps three and four would in such embodiment be replaced with selecting the reactor model associated with the provided catalyst type.

The reactor model may include a system of differential algebraic equations that describe the change in state variables along the axial (length) direction of the reactor. The differential equations may represent the mass, energy and momentum balances. Further algebraic equations may be constitutive equations describing reaction properties, such as reaction rates and thermodynamic properties. The kinetic parameters may relate to the reaction kinetics of the reactor model.

The reactor model may be based on a system of differential algebraic equations (DE) that express the changes, e.g., in mass, energy, momentum, that occur within the reactor during the catalytic reaction, such as the oxidation of sulfur dioxide. Such DEs are for instance described in literature O. Levenspiel, Chemical Reaction Engineering, 3rd ed. Wiley, 2019; S. Li, F. Xin, and L. Li, Reaction engineering. Butterworth-Heinemann, 2017. This is merely an example and should not be considered limiting.

The system of DEs may use thermodynamics and respective kinetics, based on kinetic and equilibrium parameters, that describe the reaction rates of the chemical reactions. One example of an reaction rate equation based on the results for oxidation of SO2 over industrial catalyst is for instance provided in P. A. Sörensen, M. Möllerhöj, and K. A. Christensen, New dynamic models for simulation of industrial so2 oxidation reactors and wet gas sulfuric acid plants,” Chemical Engineering Journal, vol. 278, pp. 421 429, 2015. This is merely an example and should not be considered limiting.

The kinetic parameters may be determined experimentally from historical measurement data or from historic plant operation data per catalyst type. The kinetic parameters in the system of differential equations may for instance be determined by fitting the kinetic parameters to measured values that reflect the output of the differential equations. If such historical measurement data is measured at laboratory scale, the result of such fitting may be compared to historical plant operation data to ensure that the kinetic parameters of the kinetic model reflect the production setting. Each parametrized kinetic model or parametrization may be associated with metadata signifying the catalyst type.

With different reactor models per catalyst type, the reactor performance may be determined for more than one catalyst types or combinations of catalyst types. Stacked configurations with more than one catalyst type in one or a single reactor component or more than one catalyst type in several reactor components may be determined. Such flexibility allows to provide more reliable catalyst configurations and improves the overall performance of the reactor.

In yet another embodiment, kinetic parameters may be associated with individual catalyst components. In such embodiments, the parameters may be selected based on the components provided by the catalyst composition. The kinetic parameters for the composition may be determined based on a weight function. This may be a weighted average, weighted by activity, weighted by amount, weighted by yield, weighted by conversion or a yield molecule class specific weight. The determined parameters for the composition may be used in the reactor model framework. Such embodiment allows for more tailored determination of catalyst configuration.

In a fifth step, the reactor performance may be determined for the catalyst configuration based on the generated or selected (not shown embodiment) reactor model. The reactor performance may be determined by providing the reactor data and catalyst configuration data to the reactor model. As lined out above the reactor model may be provided based on the catalyst configuration performance. The reactor performance may include, but is not limited to, one or more of the following parameters: a conversion, a yield, an operation condition or a selectivity. The reactor performance may be determined for the reactor, for each component of the reactor or for multiple components of the reactor or for any position within the reactor. Based on the reactor models for the various catalyst configurations, e.g. catalyst types, the dynamic profiles of the catalytic reactor may be determined, and the reactor performance may be derived. A dynamic profile or trajectory may be a trajectory (the various values) a state variable has in the reactor system. The reactor performance may include conversion or emission values, and the simulated end states to derive e.g. yield or pressure drop.

The DEs of the reactor model may be solved by known numerical solvers. If the numerical solvers do not allow for the solution of DEs, then, e.g., via an appropriate discretization method, the DEs can be transformed into a system of algebraic equations that may be solved numerically.

In a sixth step, the reactor performance for the catalyst configuration, e.g., the at least one catalyst volume and type of the reactor may be provided. The determined reactor performance may be provided via a network 500 from the computing device 42 to the client device. The client device may include a user interface and the determined reactor performance may be displayed to an operator filling the reactor. In other embodiments, multiple or all steps may be executed on a single computing device such as the client device.

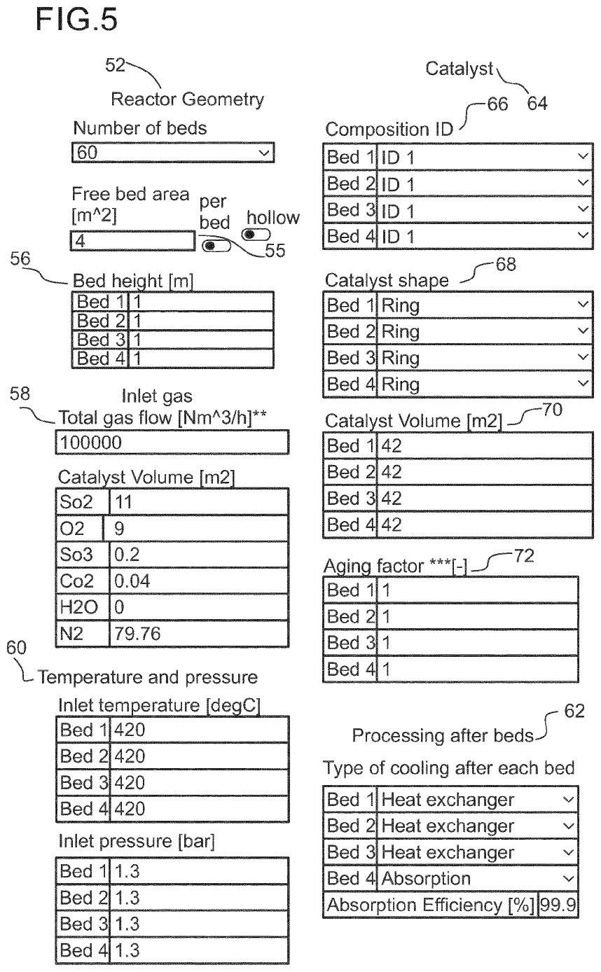

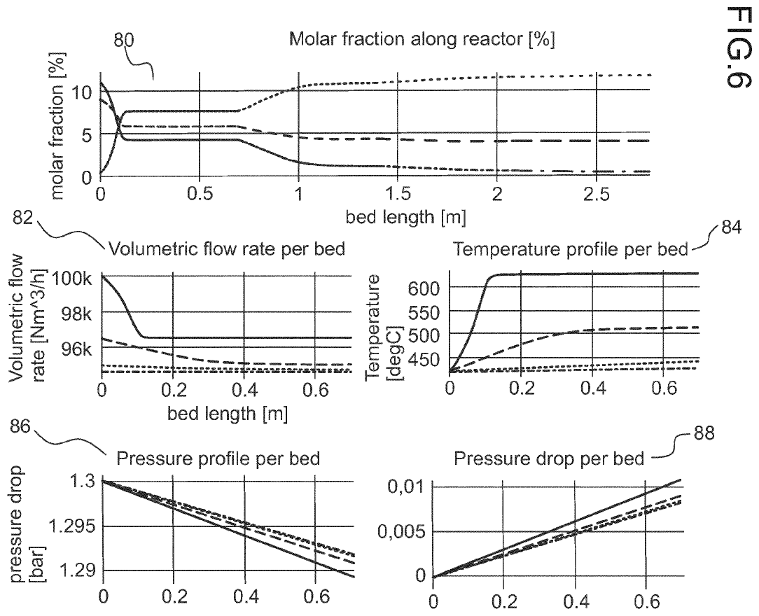

FIG. 5 illustrates the input interface for determining the reactor performance as it may be used in the methods described herein. The example shows an input mask for a cylindrical fixed bed reactor. This is, however, not limiting and any reactor geometry may be used.

The reactor data may be provided by the user specifying the reactor geometry 52. In case of a fixed bed reactor the number of beds as well as the free bed area 55 and height 56 may be provided for the reactor or per bed. The bed area may further be specified for a non-hollow cylinder having one diameter for a round bed or a hollow cylinder having an inner and an outer diameter for a round bed. Furthermore, the inlet gas 58 may be specified in terms of total gas flow and gas composition. In addition inlet temperature and pressure 60 may be provided.

The catalyst data 64 may be provided by the user specifying catalyst composition 66 per bed, e.g. via a brand name, a composition identifier or individual components, a catalyst shape 68 per bed and a catalyst volume 70 per bed. The catalyst volume 70 may be determined based on the reactor data, in particular the bed volume may be determined. In such case a specification of catalyst volume may not be required.

An aging factor 72 per bed, an inlet temperature 60 per bed and an inlet pressure 60 per bed may be provided. An inlet gas 58, in this example for a sulfuric acid production, may be provided. Processing components of the reactor after each bed 62 may be provided.

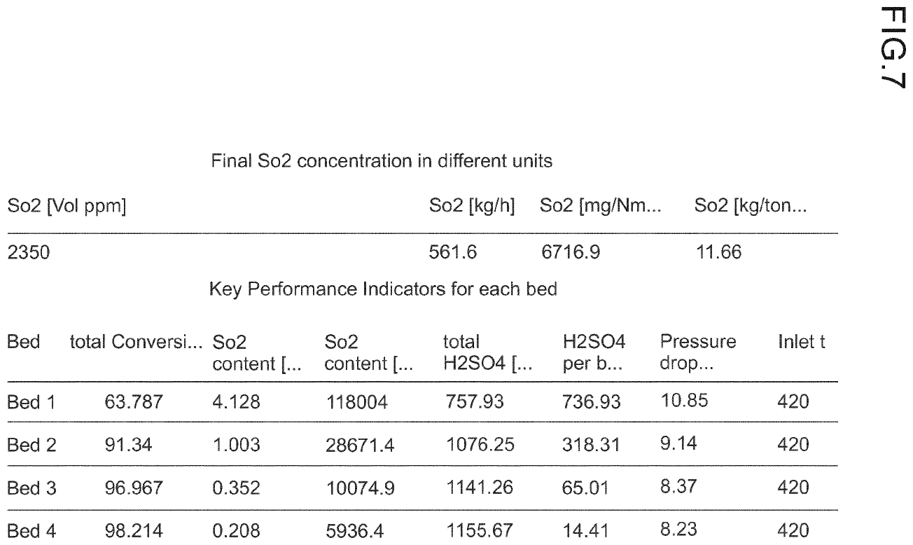

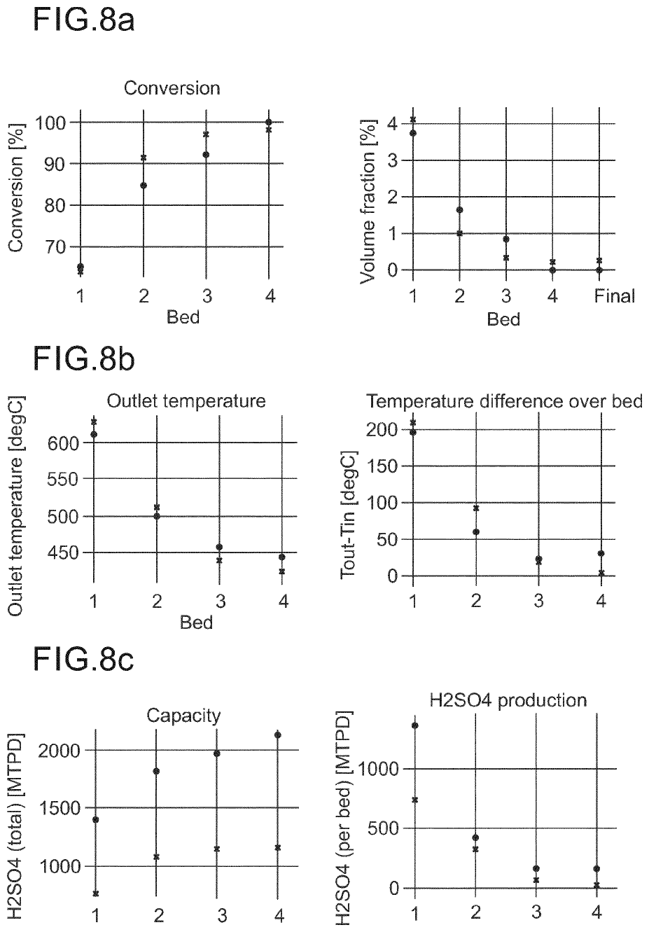

FIGS. 6, 7, 8 illustrate results from the method for determining reactor performance for the example performance of a reactor in a sulfuric acid production plant.

The top graph 80 of FIG. 6 shows molar fraction vs. bed length for each bed and each molecule. The second row shows on the left side the volumetric flow rate vs bed length per bed 82 and on the right side the temperature vs. bed length per bed 84. The third column shows the pressure vs bed length per bed 86 on the left and pressure drop vs. bed length per bed 88 on the right.

FIG. 7 illustrates the tabular output for a reactor in a sulfuric acid production plant including the final SO₂ concentration in outlet stream and key performances. The key performances per bed shown here are total conversion, SO₂ content, cumulative H₂SO₄ production, H₂SO₄ production per bed, and pressure drop. Other performances of the reactor may be inlet and outlet temperature per bed.

FIGS. 8a, b, c show comparison plots for different inputs in terms of catalyst configuration including catalyst type and catalyst volume. Here two configurations with different catalyst volumes were chosen. In FIG. 8a, conversion and SO₂ emission are compared for different catalyst configuration. In FIG. 8b, outlet temperature and temperature difference over the beds are shown. In FIG. 8c, capacity and H₂SO₄ production are compared. For the two different catalyst configurations chosen here, the main difference lies in the capacity, conversion and SO₂ emission of the reactor. In configuration one the capacity is higher than in configuration two, while conversion, SO₂ emission and H₂SO₄ production are similar.

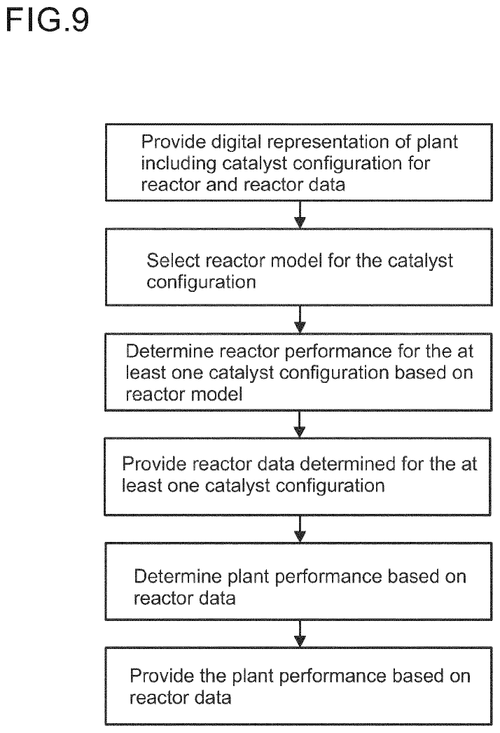

FIG. 9 illustrates a flow diagram of one example method for determining a plant performance for the catalyst configuration.

In the first step, the plant model including catalyst configuration data and reactor data is provided. The plant model may relate to a process model of a production plant as input to a flow sheet simulation. The flow sheet simulation may solve energy and mass balance equations based on chemical input parameters, unit operations and operating conditions. It is also possible to optimize the process parameters in addition to the catalyst type and volume. In the second step, the reactor model for the catalyst configuration is selected. In the third step, the reactor performance for the at least one catalyst configuration based on reactor model is determined. In the fourth step, reactor data determined for the at least one catalyst configuration is provided. In a fifth step, the plant performance based on reactor data is determined. Here the reactor data may include reactor layout, reactor operation parameters and/or reactor performance. The specific catalyst configuration may or may not be included. In the sixth step, the plant performance based on reactor is provided. This allows tailoring the catalyst configuration directly to the specific plant and the resulting plant performance.

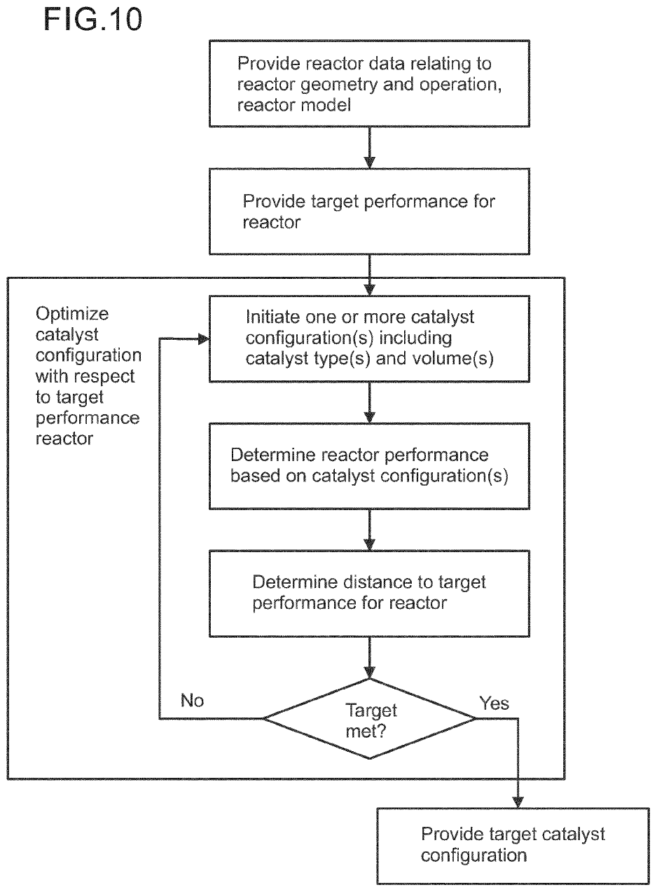

FIG. 10 illustrates a flow diagram of one example method for optimizing the catalyst configuration.

In the first and second step, reactor data and target performance for reactor may be provided. Such data may be provided via a network from the client device or any computing device 40, 42, 44. The user may specify the reactor system, e.g., reactor geometry, number of fixed beds, the inlets into each individual fixed bed, e.g., inlet flow rates, inlet temperatures, as well as the various processing steps between the fixed beds, if more than one is present. In another embodiment, reactor data may be provided via the computing device 40, 42, 44 accessing the storage device storing the reactor data.

In the third step, one or more catalyst configuration(s) including catalyst type(s) and volume(s) may be initiated. Such initiation includes a catalyst type and a catalyst volume for each bed in the reactor. The user may specify various catalyst types as well as the maximum number of catalyst types inside each bed. The catalyst volume may be initialized automatically based on the reactor specification. The catalyst type may be predefined or dynamically selected depending on the reactor data.

In the fourth step, reactor performance based on catalyst configuration(s) may be determined. In the fifth step, a distance between the target reactor performance and the determined target performance may be determined. In the sixth step, the distance to e.g. a predefined stop criterion is determined and checked. Is the stop criterion not met, the process iterates with different catalyst type(s) i+1 and catalyst volume i+1. The reactor performance and its distance from the target reactor performance is determined for one or more catalyst type(s) i+1 and catalyst volume i+1. For more than one catalyst type and for more than one catalyst volume associated with the catalyst type(s) the performance parameter is determined until the stop criterion is met. In the last step, the performance target catalyst type and catalyst volume are output optionally with the target reactor performance.

Based on the system of DEs and the kinetic models for the various catalyst types, the optimal catalyst type(s) and associated volume are determined via the solution of an optimization problem. In a fixed bed reactor, the catalyst volume or amount, the catalyst shape and the stacking configuration in each bed may be determined. This way, specifications for, e.g., a sulfuric acid reactor system are fulfilled.

In other embodiments, different optimization problems may be solved. For instance, other variables may be optimized. One practically relevant example may be on reactor component, e.g. bed, catalyst exchange. In such cases where only one component with catalyst is exchanged the aging of the other components may be taken into account and the optimization of catalyst configuration may be executed only for the one component catalyst is to be exchanged for, while considering the effect of the remaining components. For instance, an aging factor may be included into the reactor model relating to the unchanged components. Such an aging factor may be determined from historical measurement data or may be given by an average value.

In the embodiments described here, the target reactor performance may be determined by iteratively determining for different catalyst types and catalyst volumes respective reactor performances until an objective function reaches a target objective signifying the target catalyst types and associated target catalyst volumes. Non-iterative methods for optimization may also be used. In such cases the target performance may be determined e.g. for different catalyst types, catalyst volumes and target objectives in a multi-dimensional map with respective performances. The target objective may then be searched in this multi-dimensional space to determine the target objective signifying the target catalyst types and associated target catalyst volumes. The target objective may in both cases be determined based on a local optimization method, a global optimization method, metaheuristic method or a combination of these methods providing local, global or statistical target catalyst types and associated target catalyst volumes. The objective function may be based on output of the reactor, output composition of the reactor, catalyst performance, or profitability of the reactor.

In other embodiments the methods may include in the first step, the digital representation of the production plant based on a production plant layout and a target performance parameter may be provided. The digital representation relates to a process model of a production plant input to the flow sheet simulation. The target performance parameter may be related, but is not limited to, one or more of the following parameters: product output, product output composition, energy usage, maintenance intervals. In the second step, a performance of the reactor for e.g. the at least one catalyst volume is determined based on the catalyst type. In the third step, the performance parameter of the production plant based on the digital representation, performance of the reactor and e.g. the catalyst volume and type may be determined. Here a flow sheet simulation may be used that solves energy and mass balance equations based on chemical input parameters, unit operations and operating conditions. In the last step, the catalyst volume, catalyst type and associated performance parameter of the reactor and the production plant are provided.

Similarly, to above where optimization is done for the reactor, the optimization problem can be extended to the production plant. This may be done in an iterative or non-iterative fashion. For example, via a target objective and an objective function that may be based on but is not limited to output of the production plant, product output composition, catalyst performance, operating parameters of the production plant or profitability of the production plant.

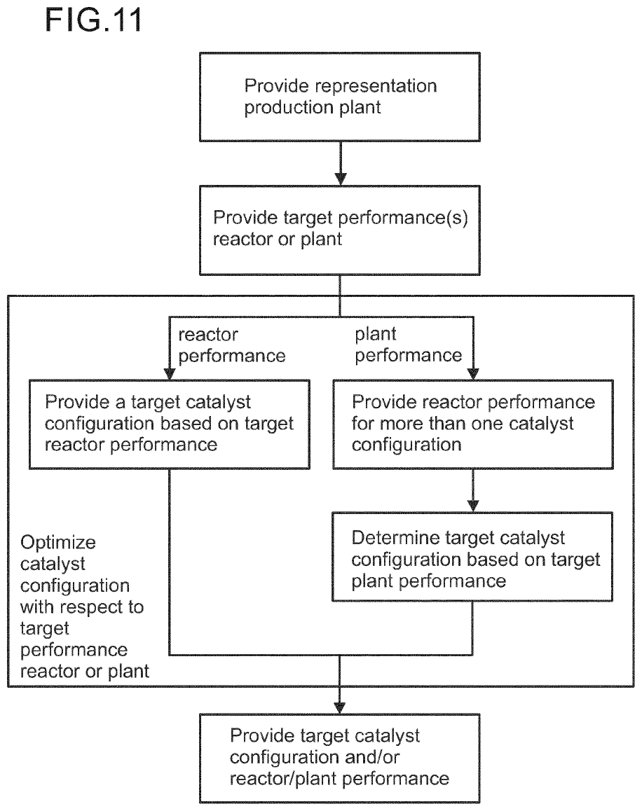

FIG. 11 illustrates a flow diagram of another example method for optimizing the catalyst configuration.

In the first step, the representation of the production plant and the target performance(s) for reactor or plant may be provided. In the second step, the catalyst configuration with respect to target performance reactor or plant may be optimized. For such step, multiple embodiments exist. For example, if the reactor performance is provided, the target catalyst configuration based on target reactor performance may be provided as determined by any of the methods described herein. For example, if the plant performance is provided, the reactor performance for more than one catalyst configuration may be provided as determined by any of the methods described herein and the target catalyst configuration may be determined based on the target plant performance. In other embodiments, the target performances may be provided for the reactor performance and the plant performance. One of these may be provided as a constraint to the optimization, while the other may define the optimization target. In the third step, the target catalyst configuration and/or the reactor and/or the plant performance may be provided.

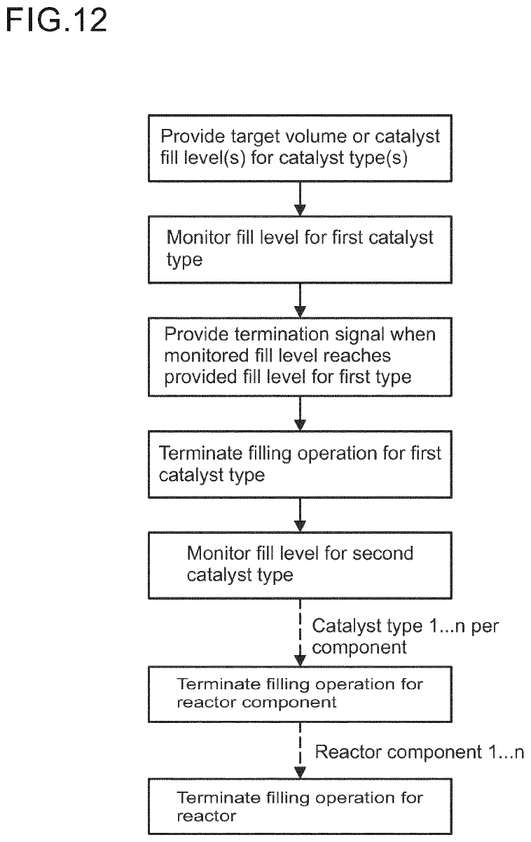

FIG. 12 illustrates a flow diagram of one example method for monitoring and controlling a filling operation.

In the first step, the target volume or catalyst fill level(s) for the catalyst type(s) may be provided. In the second step, the fill level for a first catalyst type may be monitored. Such monitoring may be done through different sensor systems such as a laser-based distance measure or fill level indicator. In the third step, a termination signal may be provided, if the monitored fill level reaches the provided fill level for the first type. In the fourth step, the filling operation for first catalyst type may be terminated. In the following steps, steps two and three may be repeated for each catalyst type to be filled e.g. in a staggered arrangement for one reactor component or for more than one reactor component. Once catalyst types are filled filling operation may be terminated for reactor component or reactor.

The filling operation may be monitored at certain stages during the filling process, e.g. after filling of a single reactor bed or after filling the reactor and prior to ramping up the production plant by pressure drop measurements. For pressure drop measurements, a test gas may be fed to the reactor or components of the reactor. Such pressure drop measurements at certain stages during or after the filling process may be used to confirm the fill level e.g. per reactor bed, per tube or per reactor. In particular, for multi tubular reactors the pressure drop may be measured for each tube. This may encompass over 10.000 tubes and measurement of the flow through each tube in a single measurement or in independent pressure drop measurements for each tube.

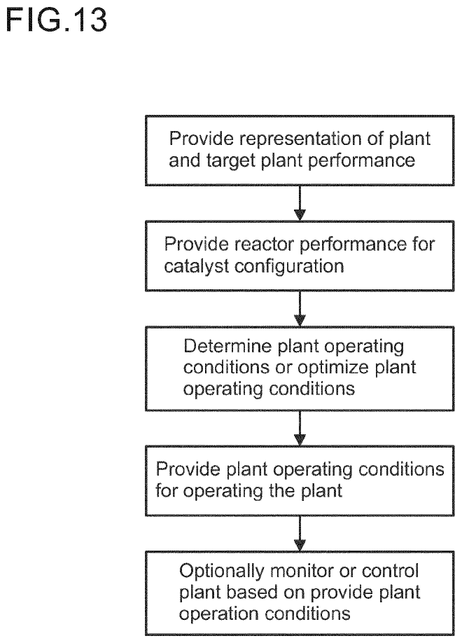

FIG. 13 illustrates a flow diagram of another example method for monitoring and controlling a production plant operation.

In the first and second step, representation of plant and target plant performance and reactor performance for catalyst configuration may be provided. In the third step, plant operating conditions may be determined or optimized and provided in the fourth step. Optionally the plant may be monitored or controlled based on provide plant operation conditions.

Other variations to the disclosed embodiments can be understood and effected by those skilled in the art in practicing the claimed invention, from a study of the drawings, the disclosure, and the appended claims.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of the plant model, the providing of the reactor model, the determining of the performance, the generating of the reactor model, etc. performed by one or several units or devices can be performed by any other number of units or devices. These procedures can be implemented as program code means of a computer program and/or as dedicated hardware.

A computer program product may be stored/distributed on a suitable medium, such as an optical storage medium or a solid-state medium, supplied together with or as part of other hardware, but may also be distributed in other forms, such as via the Internet or other wired or wireless telecommunication systems.

Any units described herein may be processing units that are part of a computing system. Processing units may include a general-purpose processor and may also include a field programmable gate array (FPGA), an application specific integrated circuit (ASIC), or any other specialized circuit. Any memory may be a physical system memory, which may be volatile, non-volatile, or some combination of the two. The term “memory” may include any computer-readable storage media such as a non-volatile mass storage. If the computing system is distributed, the processing and/or memory capability may be distributed as well. The computing system may include multiple structures as “executable components”.

The term “executable instruction or component” is a structure well understood in the field of computing as being a structure that can be software, hardware, or a combination thereof.

For instance, when implemented in software, one of ordinary skill in the art would understand that the structure of an executable component may include software objects, routines, methods, and so forth, that may be executed on the computing system. This may include both an executable component in the heap of a computing system, or on computer-readable storage media. The structure of the executable component may exist on a computer-readable medium such that, when interpreted by one or more processors of a computing system, e.g., by a processor thread, the computing system is caused to perform a function. Such structure may be computer readable directly by the processors, for instance, as is the case if the executable component were binary, or it may be structured to be interpretable and/or compiled, for instance, whether in a single stage or in multiple stages, so as to generate such binary that is directly interpretable by the processors. In other instances structures may be hard coded or hard wired logic gates, that are implemented exclusively or near-exclusively in hardware, such as within a field programmable gate array (FPGA), an application specific integrated circuit (ASIC), or any other specialized circuit.

Accordingly, the term “executable instruction or component” is a term for a structure that is well understood by those of ordinary skill in the art of computing, whether implemented in software, hardware, or a combination. Any embodiments herein are described with reference to acts that are performed by one or more processing units or computing devices of the computing system. If such acts are implemented in software, one or more processors direct the operation of the computing system in response to having executed computer-executable instructions that constitute an executable component.

Computing system may also contain communication channels that allow the computing system to communicate with other computing systems over, for example, network. A “network” is defined as one or more data links that enable the transport of electronic data between computing systems and/or modules and/or other electronic devices. When information is transferred or provided over a network or another communications connection, for example, either hardwired, wireless, or a combination of hardwired or wireless, to a computing system, the computing system properly views the connection as a transmission medium. Transmission media can include a network and/or data links which can be used to carry desired program code means in the form of computer-executable instructions or data structures and which can be accessed by a general-purpose or special-purpose computing system or combinations. While not all computing systems require a user interface, in some embodiments, the computing system includes a user interface system for use in interfacing with a user. User interfaces act as input or output mechanism to users for instance via displays.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, datacenters, wearables, such as glasses, and the like. The invention may also be practiced in distributed system environments where local and remote computing system, which are linked, for example, either by hardwired data links, wireless data links, or by a combination of hardwired and wireless data links, through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources, e.g., networks, servers, storage, applications, and services. The definition of “cloud computing” is not limited to any of the other numerous advantages that can be obtained from such a model when deployed. The computing systems of the figures include various components or functional blocks that may implement the various embodiments disclosed herein as explained. The various components or functional blocks may be implemented on a local computing system or may be implemented on a distributed computing system that includes elements resident in the cloud or that implement aspects of cloud computing. The various components or functional blocks may be implemented as software, hardware, or a combination of software and hardware. The computing systems shown in the figures may include more or less than the components illustrated in the figures and some of the components may be combined as circumstances warrant.

Any reference signs in the claims should not be construed as limiting the scope.

1. A method for determining a reactor performance for a catalytic reactor or reactor system, the method comprising:
providing reactor data indicative of a property of the catalytic reactor or the reactor system,
providing catalyst configuration data indicative of a property of at least one catalyst present in the catalytic reactor or reactor system,
providing a reactor model associated with the at least one catalyst, the reactor model being configured for determining a catalytic reaction within the catalytic reactor or reactor system based on the reactor data and the catalyst configuration data,
determining the reactor performance using the reactor data, the catalyst configuration data and the reactor model, and
providing the determined reactor performance for the provided catalyst configuration.

2. A method for determining a plant performance of a production plant with a catalytic reactor or reactor system, the method comprising:
providing a plant model including reactor data indicative of a property of the catalytic reactor or the reactor system and catalyst configuration data indicative a property of at least one catalyst present in the catalytic reactor or reactor system;
providing based on the reactor data and the catalyst configuration data a reactor performance for the catalytic reactor or reactor system determined according to claim 1,
determining the plant performance of the production plant based on the reactor performance and the plant model,
providing the plant performance of the production plant.

3. A method for providing a target catalyst configuration for a catalytic reactor or reactor system, the method comprising:
determining a reactor performance for a catalytic reactor or reactor system according to claim 1,
providing one or more target performance(s) for the catalytic reactor or reactor system, the one or more target performance(s) being indicative of a desired performance when using the catalytic reactor or reactor system with the at least one catalyst present in the catalytic reactor or reactor system,
determining the target catalyst configuration based on the determined reactor performance and the provided target performance(s), and
providing the determined target catalyst configuration.

4. The method of claim 1, wherein providing the reactor model includes generating the reactor model based on kinetic parameter(s) for different catalyst types of the at least one catalysts.

5. The method of claim 1, wherein the property of the at least one catalyst includes one or more catalyst type(s) and/or a catalyst volume associated with each catalyst type.

6. The method of claim 1, wherein providing the reactor model includes selecting kinetic parameter(s) based on catalyst type(s) of the at least one catalyst.

7. The method of claim 6, wherein the kinetic parameter(s) relate to experimental data for different catalyst types.

8. The method of claim 1, wherein the property of the catalytic reactor or the reactor system includes one or more reactor component(s) that can be filled with a catalyst of the at least one catalyst and/or the property of the at least one catalyst includes catalyst type(s) and volume(s) per reactor component to be filled with a catalyst of the at least one catalyst.

9. The method of claim 8, wherein an aging factor signifying a catalyst deactivation per reactor component is provided, wherein the performance of the reactor is determined by providing the catalyst configuration data, the reactor data and the aging factor per reactor component to the reactor model.

10. The method of claim 3, wherein determining the target catalyst configuration with respect to the provided target performance(s) includes an optimization routine determining the target catalyst configuration based on an objective function reaching a target objective.

11. A method for determining a target catalyst configuration for a production plant, the method comprising:
providing a plant model including reactor data and catalyst configuration data of a property of at least one catalyst present in a catalytic reactor or reactor system of the production plant;
in a first option comprising:
providing one or more target performance(s) for the catalytic reactor or reactor system,
providing a target catalyst configuration for the catalytic reactor or reactor system determined according to claim 3;
determining the plant performance of the production plant based on the target catalyst configuration and the plant model,
or
in a second option comprising:
providing one or more target plant performance(s);
providing a reactor performance determined according to claim 1 for at least one catalyst present in the catalytic reactor or reactor system, and
determining the target catalyst configuration with respect to the provided target plant performance(s) based on the plant model and the reactor performance for one or more catalyst configuration(s),
providing the target catalyst configuration, the plant performance and/or the reactor performance of the production plant for the target catalyst configuration.

12. A method for determining operating conditions for a production plant, the method comprising:
providing a plant model and a target plant performance;
providing a target catalyst configuration according to claim 3;
determining operating conditions for the plant based on the catalyst configuration, the plant model and the target plant performance, and
providing the operating conditions for monitoring or controlling the production plant.

13. A computer element including instructions for determining a reactor performance, a plant performance, a catalyst configuration or operating conditions, which when executed on one or more computing device(s), carry out the method of claim 1.

14. A use of the catalyst configuration generated according to the method of claim 3 for operating a plug flow reactor, for producing sulfuric acid, for monitoring a filling operation or for operation of a production plant.

15. A system for determining a reactor performance of a catalytic reactor, a plant performance, a catalyst configuration or operating conditions for a production plant, the system comprising the computer element of claim 13 and one or more computing device(s) configured for executing the instructions included by the computer element.
